(19) United States
(12) Patent Application Publication
(10) Pub. No.: US 2008/0038981 A1
(43) Pub. Date: Feb. 14, 2008

(54) Wicking quick-dry anti-microbial towel

(76) Inventor: Leslie Hanes, Campbell River (CA)

Correspondence Address: BAY AREA INTELLECTUAL PROPERTY GROUP, LLC, PO BOX 210459, SAN FRANCISCO, CA, 94121-0459, US

(21) Appl. No.: 11/503,738

(22) Filed: Aug. 14, 2006

(51) Int. Cl. D04H 13/00; B32B 15/14; B32B 15/02

(52) U.S. Cl. 442/380; 442/327; 442/376

(57) ABSTRACT

A multi-purpose, quick drying towel is provided is comprised of fabrics that use technologies that enable these fabrics to move moisture by means of accelerating capillary action, or wicking. This wicking process spreads the moisture to the surface area of the towel very quickly, moving the moisture away from the body of the user to the surface of the towel where the moisture is able to quickly evaporate. Other features include a lightweight, space saving feature for packing and travel, an anti-microbial feature so the towel is more hygienic, and/or SPF sun protection.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to towels. More particularly, the invention relates to a multi-purpose, anti-microbial towel that is able to wick moisture to the surface of the towel where the moisture may evaporate quickly.

### BACKGROUND OF THE INVENTION

There are many problems associated with traditional towels. Most are designed strictly for absorption, and they do not dry quickly. Therefore, in the example of a swimmer that is in and out of the water repeatedly at a swim meet, it would be necessary to have multiple towels for the swimmer to remain dry. A thinner wicking towel would allow the water to be distributed to the surface of the fabric, where it can evaporate more quickly, so that the towel may be reused. Thus, fewer wicking towels than traditional towels would be required in the present example.

Traditional towels are bulky and require a large amount of room to transport. Traditional towels also take a considerably longer drying time in a dryer. Furthermore, traditional towels do not generally stretch.

Bacterial growth encouraged by moisture in the fabric causes many traditional towel fabrics to smell moldy because these fabrics are not able to dry quickly. Several virtually permanent anti-microbial treatments and technologies are known to those skilled in the art. One such example, without limitation, is silver. This treatment makes fabrics very hygienic, as it does not wash out. These technologies are being utilized in many medical applications to discourage bacteria. However, this technology is not being used in wicking, or moisture management towel applications.

There are towels that are designed to absorb moisture such as, but not limited to, thick terry towel, chamois and microfiber, but none of these types of towels consider the necessity of quick drying for re-use with permanent anti-microbial properties. The real need in many applications is not huge absorption of moisture but rather fast siphoning of moisture and quick drying. Sun protection advantages in a towel are also very desirable. Ordinary towels offer a degree of sun protection but they are too hot to use at length because they are quite thick.

Moisture-management fabric technologies were designed for the apparel trade. There are many manufacturers using these methods to produce fabric for all types of clothing, particularly for the active person. However, this technology has not been applied to a towel.

In view of the foregoing, there is a need for an improved towel design that allows the towel to dry quickly and comprises anti-microbial properties. It would be further desirable if such towels could be thin yet still effective, and able to stretch. There are also needs for towels that can protect from sun exposure while removing body moisture more efficiently than traditional towels.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary towel comprised of a moisture-management fabric, in accordance with an embodiment of the present invention;

FIG. 2, FIG. 3 and FIG. 4 illustrate top views of exemplary quick drying, anti-microbial towels, in accordance with embodiments of the present invention. FIG. 2 illustrates a large rectangular towel that has been embellished, in accordance with an embodiment of the present invention. FIG. 3 illustrates a small rectangular towel that has been embellished, in accordance with an embodiment of the present invention, and FIG. 4 illustrates a square towel;

FIG. 5 illustrates an exemplary quick drying, anti-microbial towel that has been embellished, in accordance with an embodiment of the present invention.

FIG. 6 illustrates an exemplary quick drying, anti-microbial towel sewn into a bag shape, in accordance with an embodiment of the present invention.

FIG. 7 illustrates an exemplary quick drying, anti-microbial towel sewn into an example of any custom saddle pad shape, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques are described for a multi-purpose, quick drying towel.

An aspect of the present invention is to provide a multi-purpose, quick drying towel. Embodiments of the present invention are comprised of fabrics that use technologies that enable these fabrics to move moisture by means of accelerating capillary action, or wicking. This wicking process spreads the moisture to the surface area of the towel very quickly, moving the moisture away from the body of the user to the surface of the towel where the moisture is able to evaporate. Other features of various embodiments of the present invention are to provide a lightweight, space saving feature for packing and travel, and an anti-microbial feature so the towel is more hygienic. Other features of various embodiments of the present invention are to provide SPF sun protection in a lightweight towel.

Means to achieve some or all of the foregoing functions are also provided.

Other features, advantages, and object of the present invention will become more apparent and be mole readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An aspect of the present invention is to provide a multi-purpose, quick drying towel. Embodiments of the present invention are comprised of fabrics that use technologies that enable these fabrics to move moisture by means of accelerating capillary action, or wicking. This wicking process spreads the moisture to the surface area of the towel very quickly, moving the moisture away from the body of the user to the surface of the towel where the moisture is able to evaporate. Other features of various embodiments of the present invention are to provide a lightweight, space saving feature for packing and travel, and an anti-microbial feature so the towel is more hygienic. Other features of various embodiments of the present invention are to provide SPF sun protection in a lightweight towel.

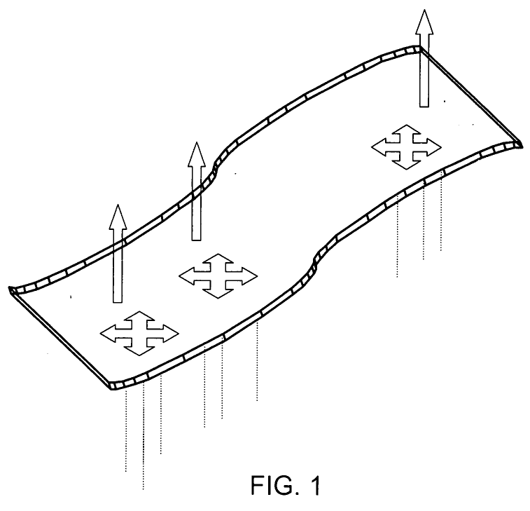

FIG. 1 illustrates an exemplary towel comprised of a moisture-management fabric, in accordance with an embodiment of the present invention. When used as a tool for drying the body from water or perspiration, and then drying out quickly for re-use, the present embodiment is more effective than traditional towels. The moisture-management fabric pulls, or wicks, the moisture from the body of the user to the surface of the fabric where it evaporates mole quickly. Furthermore, the technology incorporated into moisture-management fabrics avails itself to long lasting anti-microbial and sun protection properties that benefit the applications.

Moisture-management, or wicking, fabrics are those that use, among other things, a combination of technical attributes to improve moisture evaporation. Some of these attributes are, without limitation, the design of the cross-section of individual fibers to speed the capillary action and the construction of the knit, which is chosen by denier, or fiber size, to move from a higher denier inside to a lower denier outside because of fiber surface area. This can be seen in some wicking fabrics as virtually two separate surfaces, and in some cases bonded fabrics. Although many mills have intricacies in the process of creating wicking fabrics, capillary action or wicking is a fiber-to-fiber transference of moisture, achieved by various configurations of knit and fiber construction. The wicking is a surface modification of the fiber that enhances the capillary action to move moisture along the surface. The wicking process may be assisted by chemicals applied at very high heat to the fabric during the fabric making process for example, without limitation, in the production of yarn or in dyeing the fabric.

One example, without limitation, of a wicking fabric that may be used in embodiments of the present invention is Polartec Powerdry™ made by Malden Mills Industries. It has been sold to the military for use in next-to-skin wicking shirts and underwear. Other suitable fabrics include Visa Endurance™ made by Milliken & Company. It should be noted that reference made to an “inner layer” is intended to mean the layer that goes against the skin, and not the middle of sandwiched layers. Some embodiments of the inner layer may optionally be configured to assist in wicking and/or increase SPF sun protection.

Some embodiments may comprise a stretch component that causes the fabric to maintain a closer contact with the body, which can also help the wicking process by increasing water siphoning. In addition, a larger towel with a stretch component in the fabric can be wrapped and tied onto the body because the stretch and lightweight properties of the moisture-management fabric enable tying a knot, which would be difficult with a traditional fabric towel. Many moisture-management fabrics are polyester or polyester blends such as, but not limited to, polyester-lycra, polyester-spandex. Some moisture-management fabrics are combinations of man-made and natural fabrics, such as, but not limited to, polyester-cotton, polyester-wool, and fiber made from Corn. In the present embodiment, a polyester based wicking fabric is used, but alternate embodiments may use any fabric or combination of fabric that would result in the same or better wicking action. The preferred embodiments are comprised of light-weight fabrics because of durability and drying time, but middle or heavier weight fabrics may be used in other embodiments.

The present embodiment is also anti-microbial. Anti-microbial treatments for fabrics include, without limitation, chemical applications, natural applications such as, but not limited to, seashells or carbon, and the infusion, embedding, padding or layering of metal ions, such as, but not limited to, silver and copper into the fabric. The preferred embodiment comprises fabrics with silver technology. The silver ion can be embedded in the yarn, or coated or padded on the yarn. However, other alternatives that produce similar results may be used such as, but not limited to, natural technologies such as sea shells, activated carbon, or chemical technologies such as Triclosan™.

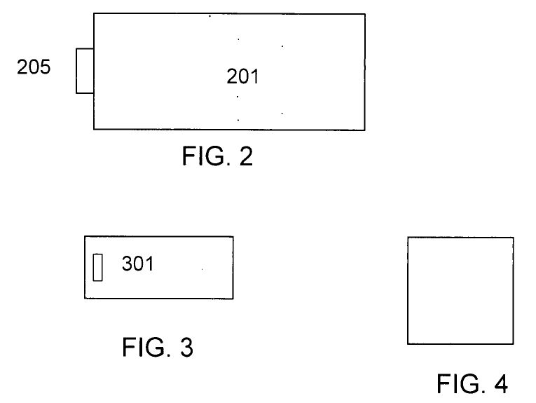

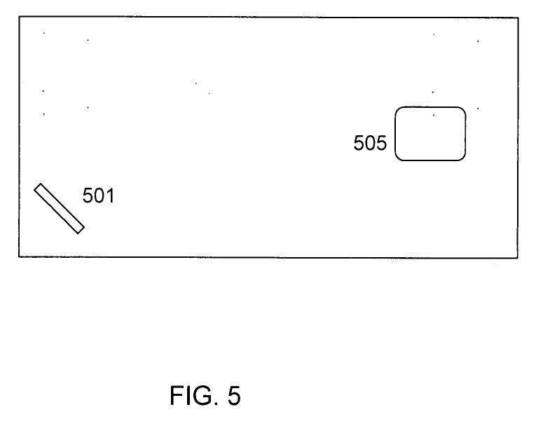

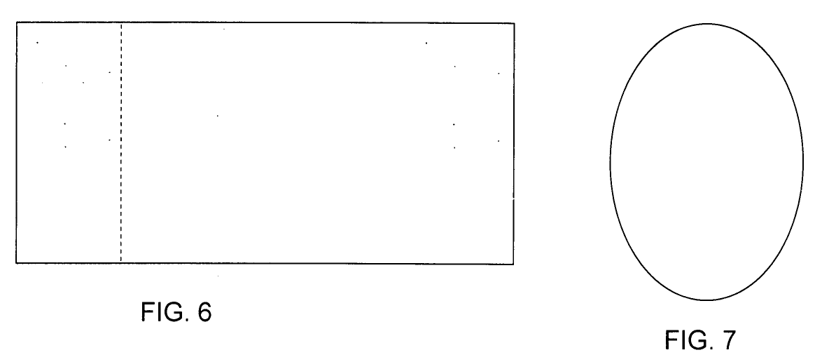

FIG. 2, FIG. 3 and FIG. 4 show top views of exemplary quick drying, anti-microbial towels, in accordance with embodiments of the present invention. FIG. 2 illustrates a large rectangular towel. FIG. 3 illustrates a small rectangular towel, and FIG. 4 illustrates a square towel. Towels designed according to embodiments of the present invention may be made in several sizes such as, but not limited to, 36″×60″, 30″×30″, 30″×15″, and may comprise hemmed fabric with appropriate labels. The size of the towel is only important in that the greater amount of moisture to be moved in a single use, the larger the towel surface should be. In some embodiments, the towel can be made as a simple rectangle or can be made in other shapes for novelty or functionality, such as, but not limited to, squares, circles, stars, flowers, abstract shapes, etc. Some embodiments may be made longer to fit on a bed, similar to a sheet or a blanket, for example, without limitations for persons suffering from night sweats. In other embodiments, as shown by way of example in FIG. 6, the towel may also be sewn in a pillow case shape to act as a nigh,it pillow towel. In these implementations, the towels move moisture from the body without having to wear the fabric. FIG. 7 shows an example of how the towel may be sewn in any custom shape to fit over a saddle pad or pet bed.

The sewing of the towel can be done in various ways, including, but not limited to, folding and/or mitering corners, coverstitching the hem, or binding the edges and finishing it in other fashions. Some embodiments may have unfinished edges. The sewing is cosmetic and may be varied; the sewing does not necessarily change the effectiveness of the towel. In some embodiments, the towel may have an additional piece of fabric added to enable the user to place it over their head or shoulders, or, as shown by way of example in FIG. 3, a hole to draw one end through, thus making a loop. In some embodiments, the towel could have a handle made of fabric or any other material, as shown in FIG. 2. The towel may have any other manner of fastening device to attach it around the neck, to a fuel belt for running, or to the body or any other object, if desired such as, but not limited to, a loop, a hook, elastic, a string attached to the towel, snaps, hook-and-loop tape, zipper etc. In some embodiments, the towel may be sewn in a loop or circle. It could be elasticized to assist in attachment to another product such as a pillow, mattress, or chaise lounge. In other embodiments, the towel may be made for use in drying animals or hair, and would be sized and shaped accordingly. For example, it could be sewn in such a way as to cover a saddle pad, to provide a means of keeping both a horse dry as well as protecting the saddle pad and keeping it clean. Or, it could be elasticized to slip over a pet bed to keep the bed protected, and the bed smelling cleaner. In yet other embodiments, the towel may be embroidered or silk-screened, may have decorative treatments, and may be made in any color.

The uses for towels according to embodiments of the present invention are widespread. The size of the towel is based on the amount of water needing to be moved, which is dependent on the application. Adult Swimmers or bathers, for example, may prefer a larger towel as the increased amount of water spreading to more surface area would maintain the speed of drying. Applications such as, but not limited to, neck towels for sports, running, or workouts would suffice with a smaller towel, as the amount of moisture would require less fabric. The smaller sizes are perfect for all sports but in particular running, where lightweight sun protection for the neck is desirable, as well as keeping the athlete dry and comfortable. A traveler or camper may choose an in-between size that is small enough to save luggage space yet large enough to dry off after a shower or bath.

FIG. 2 illustrates an exemplary quick drying, anti-microbial towel that has been embellished, in accordance with an embodiment of the present invention. In the present embodiment, the towel has a loop or handle 201 that may be used to hang the towel on an object such as, but not limited to, a hook, or to be carried like a handle.

FIG. 3 illustrates an exemplary quick drying, anti-microbial towel that has been embellished, in accordance with an embodiment of the present invention. In the present embodiment, the towel has a hole 301 in one end through which the other end of the towel may be pulled so that the towel forms a loop. This allows the user to place the towel around his neck or shoulder or to attach the towel to an object such as, but not limited to, a hook, a gym bag, etc.

FIG. 4 illustrates an exemplary quick drying, anti microbial towel approx but not limited to 30″×30″, suitable for a baby bath towel, and would also be suitable for a swim towel for a child.

The towel may also be hung on an object such as, but not limited to, a hook or knob using hole 501. The present embodiment also comprises a pocket 505. Pocket 505 allows the user to store objects in the towel. This would be particularly useful, for example, for beach goers or swimmers at a pool. In some embodiments pocket 505 may be large enough that the entire towel can be packed into pocket 505, for example, to make the towel easy to pack for travelers or to make the towel easy to carry for users such as, but not limited to, athletes, swimmers, or gym goers. In some embodiments pocket 505 may also comprise means for closure such as, but not limited to, a drawstring, a flap, snaps, hook-and-loop tape, etc.

FIG. 6 illustrates an exemplary quick drying, anti-microbial towel sewn into a bag shape, in accordance with an embodiment of the present invention. The present embodiment is sewn closed on three sides and has one open side that allows the towel to be used as a pillowcase cover, but it could also be closed or adjusted with a fastening device In other applications, this embodiment may be used to carry wet objects such as, but not limited to beach toys, damp clothes, etc.

FIG. 7 illustrates an exemplary quick drying, anti-microbial towel sewing into an oval shape to cover a saddle pad or pet bed, sewn closed to encase the object, or elasticized on the edges to cover one side if preferred.

A wicking towel is functional for travel because the towel takes very little space and dries quickly so that it can be packed soon after use.

A towel according to an embodiment of the present invention is particularly useful for an athlete because in normal use the athlete showers, then puts the damp towel in a bag where a traditional towel may start to mold quickly. A towel according to an embodiment of the present invention will not mold because of the anti-microbial treatments and because there is less moisture on the towel when it is placed in the athlete's bag. This anti-microbial quality also makes the present invention of great value to those suffering from disease or skin ulcers, where laying on a smooth anti-microbial wicking towel would assist in keeping them dry and assisting in a more hygienic and comfortable environment to lay on.

Another application of the present invention would be to enable those persons suffering from night sweats to sleep on a drier surface, when used as a bed towel or a pillow case cover.

A towel according to an embodiment of the present invention is useful for sunbathers, as they will remain dry and comfortable in the heat when laying on the towel on top of a chaise lounge, pool deck, or sandy beach.

A towel according to an embodiment of the present invention is useful for keeping an animal drier as well as protecting tack, when used between the back of a horse and the saddle pad, or for keeping a dog bed clean and a dog drier, when covering a dog bed.

Sun protection is another application for embodiments of the present invention. There are many people or groups who wish to be involved in outdoor activities but need added sun protection, such as, but not limited to, those dealing with cancer, persons on certain medications that cause sun-sensitivity, or those who are generally sun-sensitive. Traditional towels are not functional as sun protection because they are thick and may make the user hot. Embodiments of the present invention can be tied on as a cover-up or draped over the shoulders or legs as protection when sitting or walking at the beach, going for a run, or participating in outdoor activities in the sun. The thin, wicking stretch fabrics used in some embodiments are able to offer high degrees of sun protection due to their fiber content, construction, brushed back, chemical additives, as well as dyes and other treatments, while remaining cool on the body and wicking sweat away from the body.

Having filly described at least one embodiment of the present invention, other equivalent or alternative means for implementing a multi purpose, quick-drying, anti-microbial towel according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A wicking, quick-dry towel comprising a wicking, polyester moisture management, lightweight fabric configured as a towel.

2. The wicking towel of claim 1, in which said towel fabric is further configured to be finished on the edges of the fabric.

3. A wicking towel of claim 1, in which said towel fabric comprises means for managing moisture.

4. The wicking towel of claim 1, in which said towel fabric comprises means for anti-microbial action.

5. The wicking towel of claim 1, in which said towel fabric is configured to include silver or copper ions in fibers of the fabric.

6. The wicking towel of claim 1, in which said towel fabric is configured to include metal ions in fibers of the fabric.

7. The wicking towel of claim 6, in which said towel fabric comprises yarn, and said metal ions are embedded in the yarn, or coated or padded on the yarn.

8. The wicking towel of claim 1, in which said towel fabric is configured to include seashells, silver ions, activated carbon, or Triclosan™ in fibers of the fabric.

9. The wicking towel of claim 1, in which said wicking fabric is Polartec Powerdry™, or Visa Endurance™ fabric.

10. The wicking, towel of claim 1, in which said wicking fabric is any suitable polyester fabric which fabric comprises at least some of the technical attributes of Polartec Powerdry or Visa Endurance fabric.

11. A wicking, quick-dry anti-microbial towel comprising:
means for managing moisture; and
means for anti-microbial action.

12. The towel of claim 11, further comprising means for protecting the user against sun exposure.

13. A wicking, quick-dry towel comprising:
a moisture management fabric configured as a towel, said fabric having a plurality of fibers being configured to speed the capillary action from a first side of said fabric to a second side of said fabric, said first side being configured to have a higher denier value than said second side;
an anti-microbial agent configured into said towel fabric fibers; and
a sun exposure reduction agent configured in or on said towel fabric fibers.

14. The wicking towel of claim 13, in which said wicking fabric is comprises polyester or a polyester blend.

15. The wicking towel of claim 14, in which said polyester blend comprises polyester-lycra polyester-spandex, polyester-cotton, or polyester-wool.

16. The wicking towel of claim 13, in which said anti-microbial agent is a plurality of metal ions.

17. The wicking towel of claim 16, in which said towel fabric comprises yarn, and said metal ions are embedded in the yarn, or coated or padded on the yarn.

18. The wicking towel of claim 13, in which said towel fabric further comprises means for managing moisture.

19. The wicking towel of claim 13, in which said anti-microbial agent comprises means for anti-microbial action.

20. The wicking towel of claim 13, in which said towel fabric further comprises yarn, and said anti-microbial agent are embedded in the yarn, or coated or padded on the yarn.
